(19) United States
(12) Patent Application Publication
(10) Pub. No.: US 2008/0009151 A1
(43) Pub. Date: Jan. 10, 2008

(54) IC socket

(75) Inventor: Chia-Wei Fan, Tu-Cheng (TW)

Correspondence Address: WEI TE CHUNG;FOXCONN INTERNATIONAL, INC., 1650 MEMOREX DRIVE, SANTA CLARA, CA, 95050, US

(73) Assignee: HON HAI PRECISION IND. CO., LTD.

(21) Appl. No.: 11/825,892

(22) Filed: Jul. 9, 2007

(30) Foreign Application Priority Data
Jul. 7, 2006 (CN) 200620074671.3

(51) Int. Cl. H01R 12/00

(52) U.S. Cl. 439/71

(57) ABSTRACT

An IC socket includes a socket body (10) defining a plurality of passageways (102), and terminals (20) insertable into each of the passageways. A retention projection (1020) extends into the passageway. Each terminal includes a slot at a middle portion thereof for receiving the retention projection. The slot defines a closed boundary line for restricting the retention projection such that movement of the terminal along a length axis of the passageway is limited within a predetermined distance, thereby preventing the terminal from being removed therefrom.

### BACKGROUND OF THE INVENTION

1. FIELD OF THE INVENTION

The present invention relates to an IC socket for electrically connecting an IC package with a printed circuit board.

2. DESCRIPTION OF THE RELATED ART

One type IC socket typically includes a socket body having a plurality of passageways extending therethrough, and a plurality of terminals insertable into the passageways with upper contact portions of the terminals extending out of a top surface of the socket body. Such a terminal is designed to have no retention barbs for securing the terminal in the passageway. Instead, a protect cover is utilized to hold the terminal in position. Specifically, the protect cover is engageably placed onto the socket body, with a plurality of holes dimensioned to secure the upper contact portions of the terminals while permitting the upper contact portions exposed to the outside for mating with respective contact pads of an IC package. The providence of the protect cover, however, will make the manufacturing of the IC socket really complicated with additional manufacturing cost.

### SUMMARY OF THE INVENTION

An IC socket according to an embodiment of the present invention includes a socket body having a plurality of passageways, and terminals insertable into each of the passageways. The socket body defines a mating interface for facing an IC package, a mounting interface positionable adjacent a substrate, and the passageways extending from the mating interface toward the mounting interface. The passageway defines a length axis thereof. A retention projection extends into the passageway. Each of the terminals includes contact portions for engaging respective conductive elements of the IC package and the substrate, and a middle portion locatable between the contact portions. The middle portion includes a slot for receiving the retention projection. The slot defines a closed boundary line for restricting the retention projection such that movement of the terminal along the length axis of the passageway is limited within a predetermined distance, thereby preventing the terminal from being removed therefrom. Thus, no protect cover is needed to hold the terminal in position, thereby reducing the manufacturing cost of the IC socket.

Other features and advantages of the present invention will become more apparent to those skilled in the art upon examination of the following drawings and detailed description of preferred embodiments, in which:

### BRIEF DESCRIPTION OF THE DRAWINGS

FIG. 1 is an exploded, perspective view of a part of an IC socket according to a preferred embodiment of the present invention; and

FIG. 2 is an assembled, perspective view of the IC socket of FIG. 1.

### DETAILED DESCRIPTION OF PREFERRED EMBODIMENT

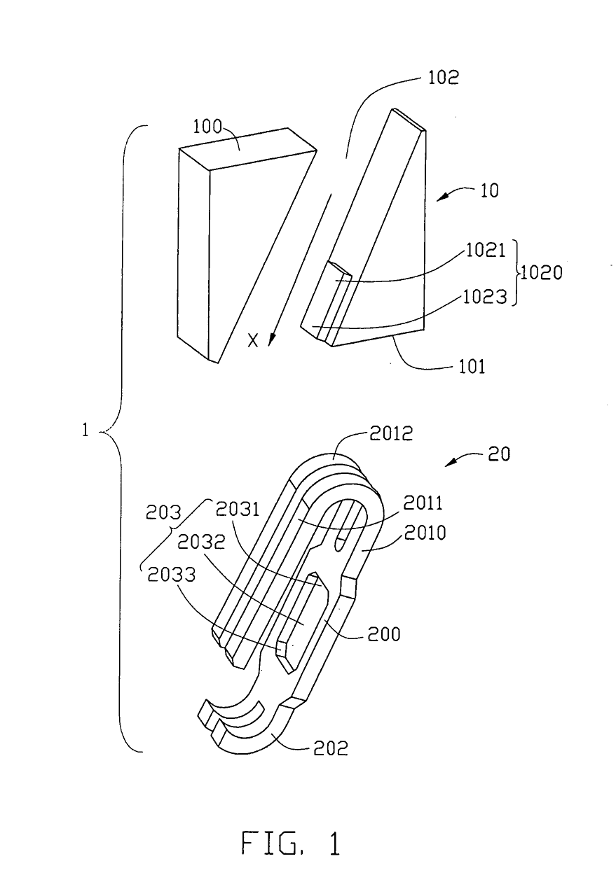

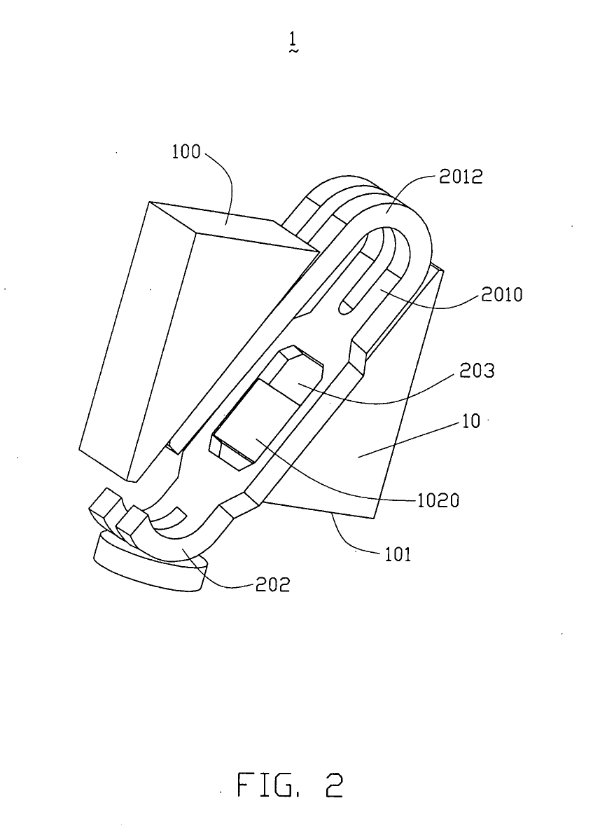

Referring to FIGS. 1 to 2, an IC socket 1 according to the preferred embodiment of the present invention is partly shown to include a socket body 10, and a plurality of terminals 20 inserted into the socket body 10.

The socket body 10 defines a mating interface 100 adapted for mating with one circuit board, such as an IC package (not shown), an opposite mounting interface 101 adapted for facing another circuit board, such as a printed circuit board (not shown), and a plurality of passageways 102 extending obliquely from the mating interface 100 toward the mounting interface 101. For the purpose of illustration, merely one passageway 102 is included herein. The passageway 102 defines a length axis ‘X’, along which the terminal 20 is movable within a predetermined distance (to be later described). A retention projection 1020 extends into the passageway 102 before the terminal 20 is fully inserted into the passageway 102. In this embodiment, the retention projection 1020 extends from a side wall of the passageway 102, and is of a rectangular shape. The retention projection 1020 defines two opposite projection ends 1021 and 1023.

Each terminal 20 is bent from a single sheet, and has double contact arms including a first resilient contact arm 2010 and a second resilient contact arm 2011 extending parallel to the length axis of the passageway 102. The terminal 20 is resiliently and engageably inserted into the passageway 102. More specifically, the first resilient contact arm 2010 and the second resilient contact arm 2011 are laterally and resiliently engagable with opposite side walls of the passageway 102 by a spring package contact portion 2012 formed at a joint of the first resilient contact arm 2010 and the second resilient contact arm 2011. The spring package contact portion 2012 of the terminal 20 is arranged to extend above the mating interface 100 for electrically mating with a conductive element of the IC package (not shown). The first resilient contact arm 2010 further includes a board contact portion 202 formed at a free end thereof and disposed opposite to the spring package contact portion 2012. The board contact portion 202 of the terminal 20 is arranged to extend below the mounting interface 101 for engaging with a conductive element of the printed circuit board (not shown). In this embodiment, each of the contact portions 2012 and 202 is provided with two contact regions divided by an aperture therebetween.

The terminal 20 further includes a middle portion 200 locatable between the spring package contact portion 2012 and the board contact portion 202, with its width thereof being larger than any of the contact portions 2012 and 202. The middle portion 200 includes an elongated slot 203 for receiving the retention projection 1020. The elongated slot 203 includes two opposite slot ends 2031 and 2033, and a middle slot section 2032 in correspondence with the retention projection 1020 for permitting the retention projection 1020 to be engageably moveable against two opposite side edges of the middle slot section 2032. Thereby, the elongated slot 203 defines a closed boundary line therebetween for restricting the retention projection 1020, with a maximum width of each slot end 2031 or 2033 at least not being larger than a minimum width of a corresponding projection end 1021 or 1023. This configuration of the elongated slot 203 allows the movement of the terminal 20 along the length axis of the passageway 102 to be limited with a predetermined distance, thereby preventing the terminal 20 from being removed therefrom. Thus, no protect cover is needed to hold the terminal 20 in position, thereby reducing the manufacturing cost of the IC socket 1.

Referring to FIG. 2, in assembly, the terminal 20 is insertable into the passageway 102 in a direction from the mounting interface 101 toward the mating interface 100. Due to the existence of the retention projection 1020 within the passageway 102, the double contact arms 2010 and 2011 of the terminal 20 are compressed to pass through the passageway 102 until the retention projection 1020 of the passageway 102 is received in the slot 203. The closed boundary line defined by the elongated slot 203 is configured to restrict the retention projection 1020 such that the movement of the terminal 20 along the length axis of the passageway 102 is limited within a predetermined distance.

While the present invention has been described with reference to preferred embodiments, the description of the invention is illustrative and is not to be construed as limiting the invention. Various of modifications to the present invention can be made to preferred embodiments by those skilled in the art without departing from the true spirit and scope of the invention as defined by the appended claims.

What is claimed is:

1. An IC socket comprising:
a socket body having a mating interface for facing an IC package, a mounting interface positionable adjacent a substrate, a plurality of passageways extending from the mating interface toward the mounting interface, the passageway defining a length axis thereof;
a retention projection extending into the passageway; and
a terminal in each of the passageways, the terminal having contact portions for engaging respective conductive elements of the IC package and the substrate, and a middle portion locatable between the contact portions;
the middle portion having a slot for receiving the retention projection, said slot defining a closed boundary line for restricting the retention projection such that movement of the terminal along the length axis of the passageway is limited within a predetermined distance.

2. The IC socket of claim 1, wherein the terminal includes double contact arms resiliently and engagably retained within the passageway.

3. The IC socket of claim 2, wherein said double contact arms extend parallel to said length axis of the passageway.

4. The IC socket of claim 2, wherein one of said contact portions is formed at a joint of said double contact arms.

5. The IC socket of claim 4, wherein another contact portion is formed at a free end of one contact arm opposite to said joint.

6. The IC socket of claim 5, wherein each contact portion is provided with two contact regions.

7. The IC socket of claim 1, wherein the retention projection includes opposite projection ends, the slot defines opposite slot ends such that a maximum width of each slot end is at least not larger than a minimum width of a corresponding projection end.

8. The IC socket of claim 1, wherein each passageway extends obliquely from the mating interface toward the mounting interface.

9. The IC socket of claim 1, wherein the middle portion has a width larger than that of any of the contact portions.

10. An IC socket comprising:
a socket body having a mating interface for facing an IC package, a mounting interface positionable adjacent a substrate, a plurality of passageways extending obliquely from the mating interface toward the mounting interface, the passageway defining a length axis thereof;
a retention projection extending into the passageway, the retention projection having opposite projection ends; and
a terminal in each of the passageways, the terminal having contact portions for engaging respective conductive elements of the IC package and the substrate, and a middle portion locatable between the contact portions;
the middle portion having a slot for receiving the retention projection, the slot defining opposite slot ends such that a maximum width of each slot end is at least not larger than a minimum width of a corresponding projection end whereby movement of the terminal along the length axis of the passageway is limited within a predetermined distance.

11. The IC socket of claim 10, wherein the terminal includes double contact arms resiliently and engagably retained within the passageway.

12. The IC socket of claim 11, wherein said double contact arms extend parallel to said length axis of the passageway.

13. The IC socket of claim 11, wherein one of said contact portions is formed at a joint of said double contact arms.

14. The IC socket of claim 13, wherein another contact portion is formed at a free end of one contact arm opposite to said joint.

15. The IC socket of claim 14, wherein each contact portion is provided with two contact regions.

16. An IC socket comprising:
a socket body having a mating interface for facing an IC package, a mounting interface positionable adjacent a substrate, a plurality of passageways extending from the mating interface toward the mounting interface, the passageway defining a length axis thereof
a retention projection extending into the passageway; and
a flexible terminal resiliently and engageably insertable into each of the passageways, the terminal having longer and shorter contact portions for engaging respective conductive elements of the IC package and the substrate, and a middle portion locatable between the contact portions;
the middle portion having an elongated slot for receiving the retention projection, said slot defining a closed boundary line for restricting the retention projection such that movement of the terminal along the length axis of the passageway is limited within a predetermined distance.

17. The IC socket of claim 1, wherein the slot is essentially located at a lower level in the corresponding passageway, and the projection is essentially located at a lower level in the passageway.

18. The IC socket of claim 1, wherein the slot is fully hidden under the longer contact portion.

19. The IC socket of claim 1, wherein at least one of said longer contact portion and said shorter contact portion defines an axial slit to form two spaced contact section, and said axial slit does not communicate with said slot.
